(19) United States
(12) Patent Application Publication
(10) Pub. No.: US 2011/0282907 A1
(43) Pub. Date: Nov. 17, 2011

(54) MANAGING ENTITLEMENTS IN A MULTI-TENANT DATABASE ENVIRONMENT

(75) Inventors: Michael Ramsey, Foster City, CA (US); Marco S. Casalaina, San Francisco, CA (US); Benjamin Tsai, San Francisco, CA (US); Michael Tang, Petaluma, CA (US); Luke Fu, San Francisco, CA (US); Rachel Wang, Foster City, CA (US)

(73) Assignee: Salesforce.com, Inc., San Francisco, CA (US)

(21) Appl. No.: 12/977,578

(22) Filed: Dec. 23, 2010

Related U.S. Application Data
(60) Provisional application No. 61/333,698, filed on May 11, 2010.

(51) Int. Cl. G06F 17/30

(52) U.S. Cl. 707/783; 707/E17.005

(57) ABSTRACT

A system and method for managing entitlements in a multi-tenant database system. In one embodiment, a method includes receiving service level definitions for one or more entitlements, and maintaining the one or more entitlements. The method further includes verifying if one or more users are eligible for the one or more entitlements, and enforcing the one or more entitlements based on the service level definitions.

### CLAIM OF PRIORITY

This application claims the benefit of U.S. Provisional Patent Application 61/333,698 entitled, “Methods and Systems for Verifying Service Entitlement in a Multi-Tenant Database Environment,” filed May 11, 2010 (Attorney Docket No. SALEP0001P), the entire contents of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

One or more implementations relate generally to entitlements in a database network system.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which, in and of themselves, may also be inventions.

In conventional database systems, users access their data resources in one logical database. A user of such a conventional system typically retrieves data from and stores data on the system using the user's own systems. A user system might remotely access one of a plurality of server systems that might in turn access the database system. The database system may store resources for providing support for customers. Even with such resources, providing adequate support to customers can be costly and difficult to achieve.

### BRIEF SUMMARY

Embodiments provide mechanisms and methods for managing entitlements in a multi-tenant database environment. In one embodiment, a method includes receiving service level definitions for one or more entitlements, and maintaining the one or more entitlements. The method further includes verifying if one or more users are eligible for the one or more entitlements, and enforcing the one or more entitlements based on the service level definitions.

While one or more implementations and techniques are described, one or more embodiments may be implemented in a system having an application server providing a front end for an on-demand database service capable of supporting multiple tenants. The embodiments described herein are not limited to multi-tenant databases or deployment on application servers. Embodiments may be practiced using other database architectures, i.e., ORACLE®, DB2® by IBM and the like, without departing from the scope of the embodiments claimed.

Any of the above embodiments may be used alone or together with one another in any combination. Embodiments described herein may also include embodiments that are only partially mentioned or alluded to, or are not mentioned or alluded to at all in this brief summary or in the abstract. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

### BRIEF DESCRIPTION OF THE DRAWINGS

In the following drawings like reference numbers are used to refer to like elements. Although the following figures depict various examples, the embodiments described are not limited to the examples depicted in the figures.

FIG. 1 illustrates a block diagram of an example environment, which may be used to implement the embodiments described herein.

FIG. 2 illustrates an example simplified flow diagram for managing entitlements in a multi-tenant database environment, according to one embodiment.

FIG. 3 illustrates an example diagram showing an example entitlement that is associated with a service contract, according to one embodiment.

FIG. 4 illustrates a block diagram of an example environment where a database service might be used, and which may be used to implement the embodiments described herein.

FIG. 5 illustrates a block diagram of another example environment, which may be used to implement the embodiments described herein.

### DETAILED DESCRIPTION

### General Overview

Systems and methods are provided for managing entitlements in a multi-tenant database environment.

As used herein, the term multi-tenant database system refers to those systems in which various elements of hardware and software of the database system may be shared by one or more customers. For example, a given application server may simultaneously process requests for a great number of customers, and a given database table may store rows for a potentially much greater number of customers.

Next, mechanisms and methods for managing entitlements in a multi-tenant database environment will be described with reference to example embodiments.

### System Overview

Embodiments described herein enable, facilitate, and manage entitlements in a database environment such as an on-demand database services system. Such an on-demand services system may be based on a multi-tenant cloud computing model. Embodiments enable a user to provide service level definitions for one or more entitlements. In one embodiment, the system maintains entitlements, verifies whether particular customers or end-customers are eligible for the entitlements, and enforces the entitlements based on the service level definitions. These aspects are described in detail below.

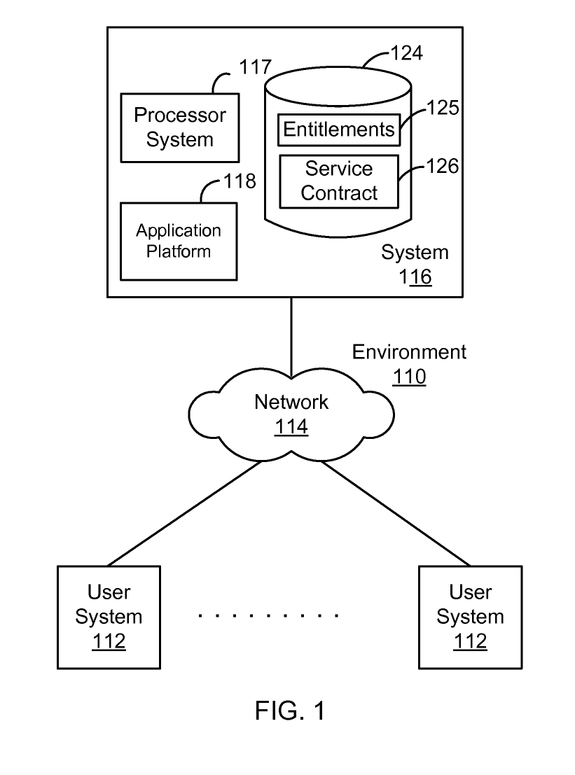

FIG. 1 illustrates a block diagram of an example environment 110, which may be used to implement the embodiments described herein. In one embodiment, environment 110 includes one or more user systems 112, a network 114, and a system 116. In one embodiment, system 116 includes a processor system 117, an application platform 118, and system data storage 124. In one embodiment, system data storage 124 stores information associated with entitlements 125 and information associated with service contracts 126. In other embodiments, environment 110 may not have all of the components listed and/or may have other elements instead of, or in addition to, those listed above.

For ease of illustration, FIG. 1 shows one block for each of user systems 112, processor system 117, and system data storage 124. These blocks 112, 117, and 124 may represent multiple user systems, processor systems, and system data storage units. As described in more detail below, system 116 performs functions for managing entitlement and service contracts.

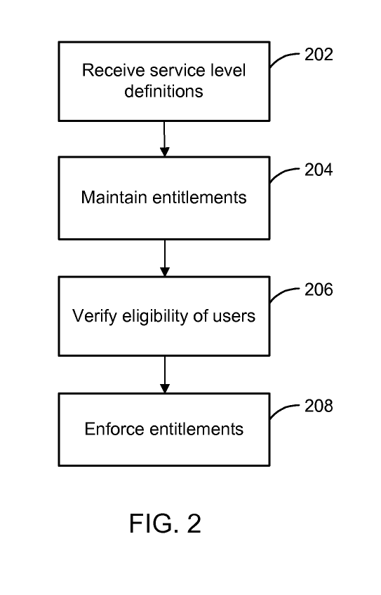

FIG. 2 illustrates an example simplified flow diagram for managing entitlements in a multi-tenant database environment, according to one embodiment. Referring to both FIGS. 1 and 2, the method is initiated in block 202, where system 116 receives service level definitions for one or more entitlements. In one embodiment, an entitlement may be a service entitlement.

In one embodiment, a service level defines entitlement processes and milestones used to provide support services to customers. In one embodiment, service levels may include tiered service offerings (e.g., platinum level, silver level, gold level, etc.) having different entitlement processes 308 and milestones 310, which may vary by price, asset, etc. In one embodiment, the phrase “service level” and “service level agreement” (SLA) may be used interchangeably.

System 116 receives the service level definitions from users of the on-demand database services system. In one embodiment, a given user may provide information for service level definitions via a user interface at a user system (e.g., user system 112). In one embodiment, a user may be an administrator of the on-demand database services system (e.g., system 116) to provide support products to its customers. In one embodiment, a user may be a customer using the on-demand database services system to provide support products to its partners, resellers, distributors, and/or end-customers. The phrases “support products” and “support programs” are used interchangeably. In one embodiment, system 116 may store the service level definitions in system data storage 124 or in any other suitable storage location.

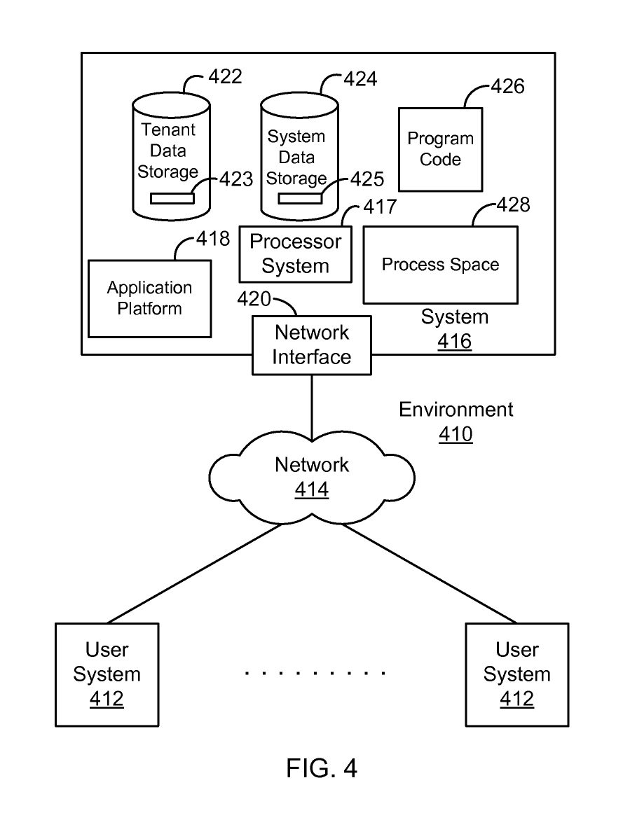

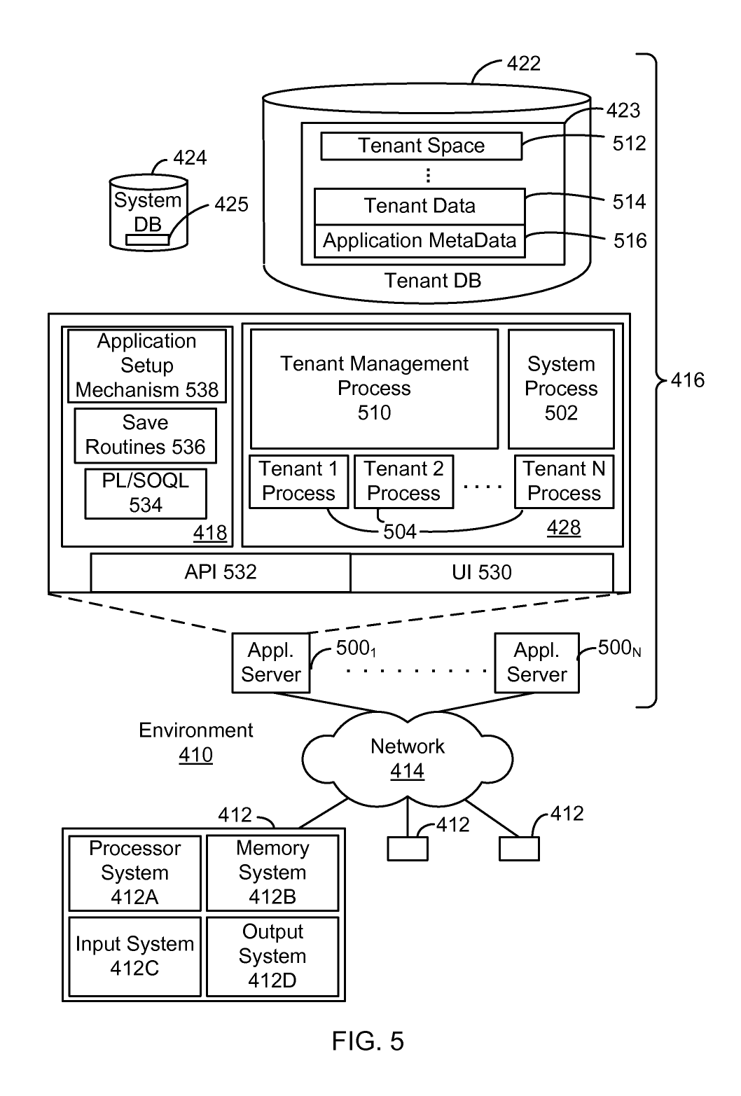

While system 116 is described as performing the steps as described in the embodiments herein, any suitable component or combination of components of system 116 or any suitable processor or processors associated with system 116 may perform the steps described. For example, the steps may be performed by processor system 417 or process space 428 of FIG. 4, by system process 502 of FIG. 5, or by any other suitable processor or processors associated with system 116.

In one embodiment, an entitlement may be associated with a service contract, where the service contract contains one or more entitlements. In one embodiment, a service contract may also include subscription contracts, maintenance agreements, warranties, other types of service contracts, etc.

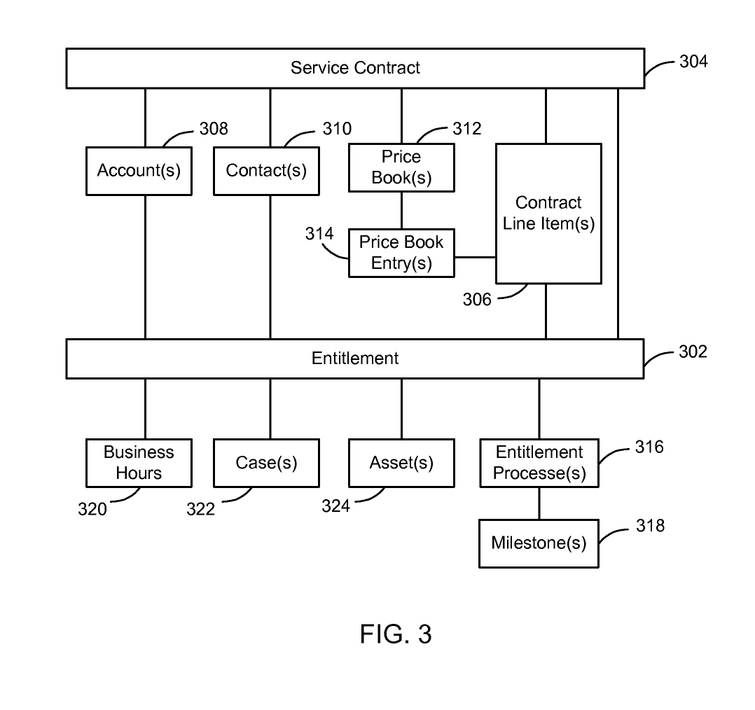

FIG. 3 illustrates an example diagram showing an example entitlement 302 that is associated with a service contract 304, according to one embodiment. In one embodiment, a customer may be eligible for one or more entitlements as a part of a support product. A support product may be included in a service offering, included in a service upgrade, or may be bundled with a product. In one embodiment, when an order for a support product is made (e.g., a customer purchases a service offering, service upgrade, or product), a contract line item 306 in service contract 304 is created. Such a purchase may involve, for example, a software license, a subscription (e.g., with patches, etc.), a product bundled with the support product, etc. In one embodiment, a service offering may include web support, phone support, training, downloads, etc. In one embodiment, one or more contract line items 306 may indicate one or more support products that were purchased. In one embodiment, entitlement 302 may be at least in part co-termed with service contract 304 (e.g., common end date).

In one embodiment, entitlement 302 and service contract 304 may be associated with one or more accounts 308 (e.g., customer account, partner account, etc.), one or more contacts 310 (e.g., customer contact entitled to call for support). In one embodiment, service contract 304 may be associated with one or more price books 312 and one or more price book entries 314. In one embodiment, contract line items 306 may be based on price book entries 324.

In one embodiment, entitlement 302 is associated with one or more entitlement processes 316 and one or more milestones 318. A service level definition may define the one or more entitlement 316 processes and milestones 318, which are described in more detail below. In one embodiment, a given entitlement process 316 may include definitions of SLA, which may be associated with particular milestones. In one embodiment, SLAs may include service metrics (e.g., response times, resolution times, actions, enforcement rules, etc.). In one embodiment, actions may include warnings (e.g., email alerts), notifications, field updates, outbound messages, creation of tasks, restoring services, etc. For example, actions may also include warnings of actions that have not been completed or that have not been completed by scheduled deadlines associated with specific milestones. In one embodiment, a given entitlement process may include adding milestones. In one embodiment, deadlines to complete milestones may be by-the-minute.

In one embodiment, milestones 318 may include internal and external milestones. Internal milestones may include milestones to be met by the support provider, and external milestones may include milestones to be met by the customer or end-customer. In one embodiment, milestones 318 may be associated with the actions in one or more entitlement processes 316. System 116 may add milestones 318 as needed.

In one embodiment, an entitlement may be associated with a case 320. In one embodiment, a given case 320 may be opened in order to address issues associated with an entitlement. This enables services for providing support to customers who are entitled to support, and ensures that customers receive the correct level of service.

In one embodiment, a case may include several fields. For example, one or more criteria fields may be used to define in what cases a given milestone will apply. In one embodiment, such criteria fields may include criteria indicating priority and/or severity. In one embodiment, the higher the priority of a case, the tighter (shorter) the time required to resolve the case according to the service level definitions. In one embodiment, criteria fields may also include customer and product attributes. In one embodiment, one or more case origin fields may be used in milestone criteria to handle cases such as phone support, which may or may not require a first response.

In one embodiment, one or more success fields may be used to update workflow actions for each of the milestones associated with a given case. In one embodiment, one or more Boolean fields may be used for each milestone completed (e.g., first response completed, etc.). In one embodiment, a Boolean field may be set to true by the field update workflow action. Then, a trigger monitors the Boolean field and grabs a milestone completion date when it is set to true and copies the completion date to another field (e.g., first response completion date).

In one embodiment, an entitlement may be associated with particular business hours 322. In one embodiment, the times that actions may be performed may be during business hours of the customer receiving support (with exceptions such as holidays).

In one embodiment, an entitlement may be associated with an asset 324. An asset 324 may be an instance of a product, a service offering, a service upgrade, etc. In one embodiment, one or more entitlements may cover a specific asset (e.g., product, service product, etc.) that a customer has purchased. In other words, an asset may be covered by one or more entitlements. In one embodiment, multiple assets may be covered by the same entitlement.

The relationships of elements of FIG. 3 are not limited to the configuration shown in FIG. 3. In other embodiments, other configurations are possible. Furthermore, other embodiments may have other elements instead of, or in addition to, those shown in FIG. 3.

In block 204, system 116 maintains entitlements. In one embodiment, system 116 may maintain entitlements by creating new entitlements, modifying existing entitlements, extending entitlements, and renewing entitlements. In one embodiment, each entitlement may be associated with a user (e.g., customer, end-customer, etc.). In one embodiment, system 116 may maintain entitlements when new assets are created (e.g., new product, new service product such as a standard warranty entitlement, etc.), when new contract line items in a service contract are created, etc.

In one embodiment, system 116 generates new entitlements from entitlement templates using default values. In one embodiment, an entitlement template may be used to model different services that are sold or included in product sales to customers and partners. For example, different service may include web support, phone support, training, downloads, etc. In one embodiment, each entitlement template may be associated (e.g., bundled) with a particular product. Such template-product associations may be defined in the service level definitions.

In one embodiment, system 116 may create entitlements when creating assets (e.g., standard warranty entitlements) and when adding contract line items (e.g., service products can bundle one or more entitlements). In one embodiment, system 116 may manage which customer contacts are entitled to a given entitlement, and delegate/require end-customers to manage their own entitlements via a user interface (UI) or application programming interface (API).

In one embodiment, system 116 may generate entitlements and related service contracts, warranties, etc. for new customers or for existing customers (e.g., associated with data migration efforts). In one embodiment, account, contact, asset, and product relationships are all supported.

In one embodiment, system 116 may also maintain service contracts, where each service contract may be associated with a user (e.g., customer, end-customer, etc.). In one embodiment, system 116 may maintain service contracts by creating new service contracts, modifying existing service contracts (e.g., adding, removing, or modifying contract line items), extending service contracts, and renewing service contracts.

In one embodiment, system 116 may maintain a service contract using the same data model with opportunities and quotes including price books. In one embodiment, a service contract may be created via an application programming interface (API) such that the service contract easily integrates with external order management systems.

In one embodiment, system 116 may maintain a service contract from an order when a customer purchases a subscription, maintenance agreement, or a warranty. This may be done explicitly via a service product as a line item on the order, or it may be bundled as part of a sales product. In one embodiment, the order may reside in an external order management system.

In one embodiment, system 116 may maintain a service contract via integration with an external system, which may provide additional service contract information. In this scenario, a service contract may contain a subset of the information that a records system may maintain. Such information may include customer information, and is used for integrating with the sales and renewal processes.

In one embodiment, service contract renewal opportunities may be created based on existing service contracts. For example, in one embodiment, system 116 may create renewal opportunities based on contract expiration (e.g., effective dates).

In block 206, system 116 verifies if one or more users are eligible for the entitlements. In one embodiment, system 116 performs the verification when a given user requests a particular support service. System 116 then determines whether the requesting user is eligible for the request service, and determines what service level of support the user is entitled to. In one embodiment, system 116 may verify a given user in a number of ways (e.g., by account, contact, asset, service contract, contract line item, product relationship, etc.)

In block 208, system 116 enforces the entitlements based on the service level definitions. In one embodiment, enforcing the entitlements includes enforcing rules (e.g., business rules) and service level details defined in the service level definitions. In one embodiment, the rules are enforced by performing actions in one or more entitlement processes defined in the service level definitions. In one embodiment, if a given customer is not eligible for a particular entitlement, the system may notify the customer of the ineligibility.

In one embodiment, the actions may be associated with email alerts, field updates, outbound messages, creation of tasks, etc. Actions may also be associated with warnings of actions not being completed or not being completed by scheduled deadlines associated with specific milestones.

In one embodiment, the enforcement of the service levels is time-dependent. For example, in one embodiment, an entitlement processes may define a timeline that includes all of the actions and milestones that a support team should complete to resolve a given case. Each entitlement process includes business logic necessary to enforce the correct service level for a given customer.

In one embodiment, deadlines associated with milestones may be based on minute-level granularity. In one embodiment, system 116 may also track actions successfully completed and metrics successfully satisfied.

In one embodiment, enforcement may involve a first response milestone and a resolution time. In one embodiment, a first response milestone may represent how quickly a support organization should respond to a customer case. This may be referred to as a response time or an initial response. In one embodiment, an initial response time may be defined as the elapsed time from when a case is opened until a member of the support organization starts diagnosing the problem. In one embodiment, a response time may be marked by notifying the customer (e.g., either via email, a comment on the case, or both) that their issue is being addressed. In one embodiment, an auto-response email would not generally be acceptable as a first response, because it would rarely result in a service agent or support engineer beginning to analyze and work the case.

In one embodiment, a resolution time may be the time required to successfully resolve a customer issue. This may be, for example, the time required to fix the root cause of a case or the time required to provide a satisfactory workaround. In one embodiment, the resolution time may be the elapsed time between when a case is opened until it is resolved to the customer's satisfaction. More specifically, it will be the time from when a case was created until the case status is set to “closed,” and a date/time closed field is set with a value earlier than or equal to the current date.

In one embodiment, system 116 instructs representatives of the database system on how to resolve cases. In one embodiment, system 116 displays a user interface to a user in order to show a timeline of a series of associated actions, including associated milestones.

Embodiments described herein provide numerous benefits. For example, embodiments facilitate determining and verifying what entitlements a particular user is eligible for. Embodiments facilitate enforcement of rules (e.g., SLAs) across a customer base, which saves costs by limiting particular support products to eligible customers. Furthermore, supporting only eligible customers ensures sufficient resources to provide appropriate service quality and thus customer satisfaction.

FIG. 4 illustrates a block diagram of an example environment 410 where a database service might be used, and which may be used to implement the embodiments described herein. Environment 410 may include user systems 412, network 414, system 416, processor system 417, application platform 418, network interface 420, tenant data storage 422, system data storage 424, program code 426, and process space 428. In other embodiments, environment 410 may not have all of the components listed and/or may have other elements instead of, or in addition to, those listed above.

Environment 410 is an environment in which an on-demand database service exists. User system 412 may be any machine or system that is used by a user to access a database user system. For example, any of user systems 412 can be a handheld computing device, a mobile phone, a laptop computer, a work station, and/or a network of computing devices. As illustrated in FIG. 4 (and in more detail in FIG. 5) user systems 412 might interact via a network 414 with an on-demand database service, which is system 416. System 416 may also be referred to as a cloud service provider. System 416 provides its resources to customers (e.g., end users) as a service.

An on-demand database service, such as system 416, is a database system that is made available to outside users who do not need to necessarily be concerned with building and/or maintaining the database system, but instead may be available for more general use when the users need the database system (e.g., on the demand of the users). Some on-demand database services may store information from one or more tenants stored into tables of a common database image to form a multi-tenant database system (MTS). Accordingly, “on-demand database service 416” and “system 416” will be used interchangeably herein. A database image may include one or more database objects. A relational database management system (RDMS) or the equivalent may execute storage and retrieval of information against the database object(s). Application platform 418 may be a framework that allows the applications of system 416 to run, such as the hardware and/or software, e.g., the operating system. In an embodiment, system 416 may include an application platform 418 that enables creating, managing, and executing one or more applications developed for an on-demand database service, for users accessing the on-demand database service via user systems 412, or for third party application developers accessing the on-demand database service via user systems 412.

The users of user systems 412 may differ in their respective capacities, and the capacity of a particular user system 412 might be entirely determined by permissions (permission levels) for the current user. For example, where a salesperson is using a particular user system 412 to interact with system 416, that user system has the capacities allotted to that salesperson. However, while an administrator is using that user system to interact with system 416, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 414 is any network or combination of networks of devices that communicate with one another. For example, network 414 can be any one or any combination of a local area network (LAN), wide area network (WAN), telephone network, wireless network, point-to-point network, star network, token ring network, hub network, or other appropriate configuration. As the most common type of computer network in current use is a transfer control protocol and Internet protocol (TCP/IP) network, such as the global internetwork of networks often referred to as the “Internet” with a capital “I.” That network will be used in many of the examples herein. However, it should be understood that the networks used with the embodiment described herein use are not so limited, although TCP/IP is a frequently implemented protocol.

User systems 412 might communicate with system 416 using TCP/IP and, at a higher network level, use other common Internet protocols to communicate, such as hypertext transfer protocol (HTTP), file transfer protocol (FTP), Andrew file system (AFS), wireless application protocol (WAP), etc. In an example where HTTP is used, user system 412 might include an HTTP client commonly referred to as a “browser” for sending and receiving HTTP messages to and from an HTTP server at system 416. Such an HTTP server might be implemented as the sole network interface between system 416 and network 414, but other techniques might be used as well or instead. In some implementations, the interface between system 416 and network 414 includes load sharing functionality, such as round-robin HTTP request distributors to balance loads and distribute incoming HTTP requests evenly over a plurality of servers. At least as for the users that are accessing that server, each of the plurality of servers has access to the MTS′ data; however, other alternative configurations may be used instead.

In one embodiment, system 416, shown in FIG. 4, implements a web-based customer relationship management (CRM) system. For example, in one embodiment, system 416 includes application servers configured to implement and execute CRM software applications as well as to provide related data, code, forms, webpages and other information to and from user systems 412. The application servers are also configured to store to, and retrieve from, a database system related data, objects, and Webpage content. With a multi-tenant system, data for multiple tenants may be stored in the same physical database object. Tenant data may be arranged such that data of one tenant is kept logically separate from that of other tenants so that one tenant does not have access to another tenant's data, unless such data is expressly shared. In certain embodiments, system 416 implements applications other than, or in addition to, a CRM application. For example, system 416 may provide tenant access to multiple hosted (standard and custom) applications, including a CRM application. User (or third party application developer) software applications, which may or may not include CRM, may be supported by the application platform 418, which manages the creation and storage of the applications into one or more database objects, and executing of the applications in a virtual machine in the process space of the system 416. The terms “application,” “software application,” “software package,” “software code,” and “program code” are used interchangeably.

One arrangement for elements of system 416 is shown in FIG. 4, including a network interface 420, application platform 418, tenant data storage 422 for tenant data 423, system data storage 424 for system data 425 accessible to system 416 and possibly multiple tenants, program code 426 for implementing various functions of system 416, and a process space 428 for executing MTS system processes and tenant-specific processes, such as running applications as part of an application hosting service. Additional processes that may execute on system 416 include database indexing processes.

Several elements in the system shown in FIG. 4 include conventional, well-known elements that are explained only briefly here. For example, each user system 412 could include a desktop personal computer, workstation, laptop, PDA, cell phone, or any wireless access protocol (WAP) enabled device or any other computing device capable of interfacing directly or indirectly to the Internet or other network connection. User system 412 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 412 to access, process and view information, pages and applications available to it from system 416 over network 414. Each user system 412 also typically includes one or more user interface devices, such as a keyboard, a mouse, trackball, touch pad, touch screen, pen or the like, for interacting with a graphical user interface (GUI) provided by the browser on a display (e.g., a monitor screen, liquid crystal display (LCD) monitor, etc.) in conjunction with pages, forms, applications and other information provided by system 416 or other systems or servers. For example, the user interface device can be used to access data and applications hosted by system 416, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 412 and all of its components are operator configurable using applications, such as a browser, including computer code run using a central processing unit such as an Intel Pentium® processor or the like. Similarly, system 416 (and additional instances of an MTS, where more than one is present) and all of their components might be operator configurable using application(s) including computer code to run using a central processing unit such as processor system 417, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 416 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a read-only memory (ROM) or random-access memory (RAM), or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory integrated circuits (ICs)), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, virtual private network (VPN), LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 416 is configured to provide webpages, forms, applications, data and media content to user (client) systems 412 to support the access by user systems 412 as tenants of system 416. As such, system 416 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., object oriented database management system (OODBMS) or rational database management system (RDBMS)) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 5 illustrates a block diagram of another example environment 410, which may be used to implement the embodiments described herein. FIG. 5 also illustrates elements of system 416 and various interconnections, according to one embodiment. FIG. 5 shows that user system 412 may include processor system 412A, memory system 412B, input system 412C, and output system 412D. FIG. 5 shows network 414 and system 416. FIG. 5 also shows that system 416 may include tenant data storage 422, tenant data 423, system data storage 424, system data 425, user interface (UI) 530, application program interface (API) 532, PL/Salesforce.com object query language (PL/SOQL) 534, save routines 536, application setup mechanism 538, applications servers 500₁-500_{N}, system process space 502, tenant process spaces 504, tenant management process space 510, tenant storage area 512 (labeled “Tenant Space 512” in FIG. 5), user storage 514 (labeled “Tenant Data 514” in FIG. 5), and application metadata 516. In other embodiments, environment 410 may not have the same elements as those listed above and/or may have other elements instead of, or in addition to, those listed above.

User system 412, network 414, system 416, tenant data storage 422, and system data storage 424 were discussed above in FIG. 4. Regarding user system 412, processor system 412A may be any combination of one or more processors. Memory system 412B may be any combination of one or more memory devices, short term, and/or long term memory. Input system 412C may be any combination of input devices, such as one or more keyboards, mice, trackballs, scanners, cameras, and/or interfaces to networks. Output system 412D may be any combination of output devices, such as one or more monitors, printers, and/or interfaces to networks. As shown in FIG. 4, system 416 may include a network interface 420 (of FIG. 4) implemented as a set of HTTP application servers 500, an application platform 418, tenant data storage 422, and system data storage 424. Also shown is system process space 502, including individual tenant process spaces 504 and a tenant management process space 510. Each application server 500 may be configured to tenant data storage 422 and the tenant data 423 therein, and system data storage 424 and the system data 425 therein to serve requests of user systems 412. The tenant data 423 might be divided into individual tenant storage areas 512, which can be either a physical arrangement and/or a logical arrangement of data. Within each tenant storage area 512, user storage 514 and application metadata 516 might be similarly allocated for each user. For example, a copy of a user's most recently used (MRU) items might be stored to user storage 514. Similarly, a copy of MRU items for an entire organization that is a tenant might be stored to tenant storage area 512. A UI 530 provides a user interface and an API 532 provides an application programmer interface to system 416 resident processes and to users and/or developers at user systems 412. The tenant data and the system data may be stored in various databases, such as one or more Oracle™ databases.

Application platform 418 includes an application setup mechanism 538 that supports application developers' creation and management of applications, which may be saved as metadata into tenant data storage 422 by save routines 536 for execution by subscribers as one or more tenant process spaces 504 managed by tenant management process 510, for example. Invocations to such applications may be coded using PL/SOQL 534 that provides a programming language style interface extension to API 532. Invocations to applications may be detected by one or more system processes, which manage retrieving application metadata 516 for the subscriber, making the invocation and executing the metadata as an application in a virtual machine.

Each application server 500 may be communicably coupled to database systems, e.g., having access to system data 425 and tenant data 423, via a different network connection. For example, one application server 500i might be coupled via the network 414 (e.g., the Internet), another application server 500_{N-1} might be coupled via a direct network link, and another application server 500_{N} might be coupled by yet a different network connection. Transfer control protocol and Internet protocol (TCP/IP) are typical protocols for communicating between application servers 500 and the database system. However, it will be apparent to one skilled in the art that other transport protocols may be used to optimize the system depending on the network connection used.

In certain embodiments, each application server 500 is configured to handle requests for any user associated with any organization that is a tenant. Because it is desirable to be able to add and remove application servers from the server pool at any time for any reason, there is preferably no server affinity for a user and/or organization to a specific application server 500. In one embodiment, therefore, an interface system implementing a load balancing function (e.g., an F5 Big-IP load balancer) is communicably coupled between the application servers 500 and the user systems 412 to distribute requests to the application servers 500. In one embodiment, the load balancer uses a least connections algorithm to route user requests to the application servers 500. Other examples of load balancing algorithms, such as round robin and observed response time, also can be used. For example, in certain embodiments, three consecutive requests from the same user could hit three different application servers 500, and three requests from different users could hit the same application server 500. In this manner, system 416 is multi-tenant, wherein system 416 handles the storage of, and access to, different objects, data and applications across disparate users and organizations.

As an example of storage, one tenant might be a company that employs a sales force where each salesperson uses system 416 to manage his or her sales process. Thus, a user might maintain contact data, leads data, customer follow-up data, performance data, goals and progress data, etc., all applicable to that user's personal sales process (e.g., in tenant data storage 422). In an example of an MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 416 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 416 might also maintain system level data usable by multiple tenants or other data. Such system level data might include industry reports, news, postings, and the like that are sharable among tenants.

In certain embodiments, user systems 412 (which may be client systems) communicate with application servers 500 to request and update system-level and tenant-level data from system 416 that may require sending one or more queries to tenant data storage 422 and/or system data storage 424. System 416 (e.g., an application server 500 in system 416) automatically generates one or more structured query language (SQL) statements (e.g., one or more SQL queries) that are designed to access the desired information. System data storage 424 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects according to the embodiments described herein. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table.”

In some multi-tenant database systems, tenants may be allowed to create and store custom objects, or they may be allowed to customize standard entities or objects, for example by creating custom fields for standard objects, including custom index fields. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a computer-readable storage medium (also referred to as a machine-readable storage medium) for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

A “processor” includes any suitable hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems. A computer may be any processor in communication with a memory. The memory may be any suitable processor-readable storage medium, such as random-access memory (RAM), read-only memory (ROM), magnetic or optical disk, or other tangible media suitable for storing instructions for execution by the processor.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

While one or more implementations have been described by way of example and in terms of the specific embodiments, it is to be understood that the implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method for managing entitlements in a multi-tenant database system, the method comprising:
receiving service level definitions for one or more entitlements;
maintaining the one or more entitlements;
verifying if one or more users are eligible for the one or more entitlements; and
enforcing the one or more entitlements based on the service level definitions.

2. The method of claim 1, wherein a service level definition comprises one or more entitlement processes.

3. The method of claim 1, wherein a service level definition comprises one or more milestones.

4. The method of claim 1, further comprising generating the one or more entitlements using entitlement templates.

5. The method of claim 1, further comprising generating the one or more entitlements using entitlement templates, wherein each entitlement template is associated with a particular asset.

6. The method of claim 1, wherein the maintaining comprises one or more of modifying existing entitlements, adding new entitlements, extending entitlements, and renewing entitlements.

7. The method of claim 1, wherein the enforcing comprises performing actions associated with one or more of email alerts, field updates, outbound messages, and creation of tasks.

8. A computer-readable storage medium carrying one or more sequences of instructions thereon for managing entitlements in a multi-tenant database system, the instructions when executed by a processor cause the processor to:
receive service level definitions for one or more entitlements;
maintain the one or more entitlements;
verify if one or more users are eligible for the one or more entitlements; and
enforce the one or more entitlements based on the service level definitions.

9. The computer-readable storage medium of claim 8, wherein a service level definition comprises one or more entitlement processes.

10. The computer-readable storage medium of claim 8, wherein a service level definition comprises one or more milestones.

11. The computer-readable storage medium of claim 8, wherein the instructions further cause the processor to generate the one or more entitlements using entitlement templates.

12. The computer-readable storage medium of claim 8, wherein the instructions further cause the processor to generate the one or more entitlements using entitlement templates, wherein each entitlement template is associated with a particular asset.

13. The computer-readable storage medium of claim 8, wherein the maintaining comprises one or more of modifying existing entitlements, adding new entitlements, extending entitlements, and renewing entitlements.

14. The computer-readable storage medium of claim 8, wherein the enforcing comprises performing actions associated with one or more of email alerts, field updates, outbound messages, and creation of tasks.

15. An apparatus for managing entitlements in a multi-tenant database system, the apparatus comprising:
a processor; and
a storage device storing one or more stored sequences of instructions which when executed by the processor cause the processor to:
receive service level definitions for one or more entitlements;
maintain the one or more entitlements;
verify if one or more users are eligible for the one or more entitlements; and
enforce the one or more entitlements based on the service level definitions.

16. The apparatus of claim 15, wherein a service level definition comprises one or more entitlement processes.

17. The apparatus of claim 15, wherein a service level definition comprises one or more milestones.

18. The apparatus of claim 15, wherein the instructions further cause the processor to generate the one or more entitlements using entitlement templates.

19. The apparatus of claim 15, wherein the instructions further cause the processor to generate the one or more entitlements using entitlement templates, wherein each entitlement template is associated with a particular asset.

20. The apparatus of claim 15, wherein the maintaining comprises one or more of modifying existing entitlements, adding new entitlements, extending entitlements, and renewing entitlements.
